(19) United States
(12) Patent Application Publication
(10) Pub. No.: US 2024/0054596 A1
(43) Pub. Date: Feb. 15, 2024

(54) AUTOMATIC CENTERING AND CROPPING OF MEDIA ELEMENTS

(71) Applicant: Pitch Software GmbH, Berlin (DE)

(72) Inventors: Nils Blum-Oeste, Berlin (DE); Arthur Caillau, Berlin (DE); Jelle Akkerman, Berlin (DE)

(21) Appl. No.: 18/280,318

(22) PCT Filed: Mar. 4, 2022
(86) PCT No.: PCT/EP2022/055625

§ 371 Date: Sep. 5, 2023

(30) Foreign Application Priority Data
Mar. 4, 2021 (LU) LU102615

(51) Int. Cl. G06T 1/60; G06T 7/73; G06V 10/40; G06V 10/25; G06V 10/26; G06V 10/776

(52) U.S. Cl. CPC G06T 1/60; G06T 7/73; G06V 10/40; G06V 10/25; G06V 10/26; G06V 10/776; G06T 2207/30201; G06T 2207/20081

(57) ABSTRACT

A computer-implemented method and computer for automatic cropping of media elements using a calculated plurality of current crop areas around an area of interest in a presentation system. Identifying the area of interest within the media elements by a graphics processing unit comprises calculating a digital representation of the media elements by analyzing pixels of media elements. The method further comprises calculating one or more current crop areas surrounding the area of interest using the graphics processing unit and storing parameters of the one or more current crop areas as items of crop data in a graphics memory. The graphics processing unit is then used for selecting one of the items of crop data for cropping of the media elements to the identified area of interest using the selected items of crop data. The cropped media elements are then output to a user on a display unit displaying a canvas.

### FIELD OF THE INVENTION

The field of the invention relates to a computer implemented method and a computer for the automatic centering and cropping of media elements.

### BACKGROUND OF THE INVENTION

Effective communication with both internal and external audiences is nowadays extremely important and electronic presentations using, for example, Microsoft's PowerPoint Software or Apple's Keynote software are often used for communicating information to an audience. This software creates a canvas onto which a user can create slides comprising media elements such images, text, charts, or tables that can be formatted individually.

Such presentations can take a long time to prepare and to format correctly. Especially inserting, cropping, centering, and resizing of images or other media elements in the presentation may require a lot of time and effort by a user. If a presentation requires regular updating, the user usually needs to readjust position and size of many of the media elements already placed on the canvas. This replacement is time-consuming for the user to perform and there is therefore a need to establish an improved method for amending and reformatting the slides.

The prior art discloses solutions for the cropping, centering, and resizing of images based on a user input. For example, European Patent Application No. EP 2 293 187 A2 (Schowtka et.al., assigned to Vistaprint Technologies Ltd.) discloses an electronic document design system and a method allowing a user to crop media elements to a predefined aspect ratio. The aspect ratio is predefined by the user through selecting of an object within the document design system. A bounding box is provided to the user that can be resized and repositioned. The bounding box is automatically sized to have and retain the same predefined aspect ratio as the selected element in document design system., The media element is cropped to the selected area within the bounding box upon completion of the resizing or repositioning operation by the user. The document describes a method and system for the cropping of media elements to a bounding box selected by the user. The invention, however, remains silent on the possibility of automatically centering and cropping the media elements without the user having to resize and reposition the bounding box relative to the media element.

US Patent No US 10,546,366 B2 (Bhatt et.al., assigned to Apple Inc.) describes a method, system, and apparatus for combining a crop function of a computer with zoom, pan and straighten functions as part of a single cropping environment. This allows the user to select a portion of the media elements for cropping, apply zoom, pan and straighten transformations to the selected portion of the media elements and then crop the transformed portion of the media elements in a single utility. In one aspect, the methods include the actions of receiving user input defining a crop region within a displayed media element. The methods also include the actions of displaying a user interface including a cropping panel that is configured to display a subset of the media elements corresponding to the defined crop region. Further, the methods include the actions of receiving user input requesting to perform at least one of a zoom, rotate or translate operation on the crop region displayed in the cropping panel. The method described does not, however, offer a solution for the automatic cropping, zooming, panning, or straightening of images.

US Patent No US 9,972,111 B2 (Eckert et.al., assigned to Adobe Systems Inc.) discloses a method for the optimized cropping of media elements. The media element and an indication of an area of interest within the media element are obtained from the user. Thereafter, an amount to scale the image is determined by the method based on a size of bounding box in which the image is to be placed for display. The image can be scaled in accordance with the determined amount to scale the image and be cropped to fit within the boundaries of the container. The method allows the user to manually define an area of interest within different media elements. This area of interest is then used for the centering of the image in subsequent zooming or cropping steps. The method disclosed remains silent on the possibility of automatically identifying the area of interest within media elements or the use the identified areas of interest for automatic cropping steps.

The prior art, however, does not disclose a system or method for automatic cropping of different types of media elements allowing to automatically determine an area of interest and select a crop of the media element for showing in a document. Therefore, there is a need for a flexible computer implemented method and computer that allow the user to easily draft and edit such presentations without having to adjust every one of a plurality of media elements manually every time something in the presentation needs to be changed.

### SUMMARY OF THE INVENTION

A computer and a computer-implemented method for an automatic cropping of media elements in a presentation system are disclosed. The computer comprises a graphics memory, a graphics processing unit, and a display unit. The graphics memory is used for storing parameters of one or more current crop areas as items of crop data. The graphics processing unit is used for identifying an area of interest within the media elements, for calculating one or more current crop areas, and for cropping the media elements using the calculated crop areas. The display unit is used for displaying a canvas comprising one or more than one of the cropped media elements. The media elements can be, for example, an image, a text, a graph, or a table.

The computer-implemented method comprises identifying an area of interest within the media elements. The area of interest can be specifically relevant part of the media element, for example, a person's face, an animal, or another area of an image with high relevance to the user. The area of interest can also be, for example, a center of a text, a graph, or a table within the media elements in a case where media element is not an image of a person or object. The computer-implemented method further comprises calculating crop-areas surrounding the area of interest within the media elements. The parameters of the current crop-areas are stored in the graphics memory and later compared by the graphics processing unit. The graphics processing unit selects, based on different input parameters, one of the current crop areas stored in the graphics memory as items of crop data. The media elements are then cropped according to the parameters specified in the crop area. The computer-implemented method further comprises outputting the cropped media elements on, for example, the canvas shown on a display device of the computer.

### DESCRIPTION OF THE FIGURES

FIG. 1 shows a view of the computer for an automatic cropping of media elements.

FIG. 2 shows a detailed view of the detection of the area of interest.

FIGS. 3a, 3b, and 3c show a detailed view of the media elements with examples for the bounding box.

FIGS. 4a and 4b show a flow chart describing a computer-implemented method for an automatic cropping of the media element in the presentation system.

### DETAILED DESCRIPTION OF THE INVENTION

The invention will now be described on the basis of the figures. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

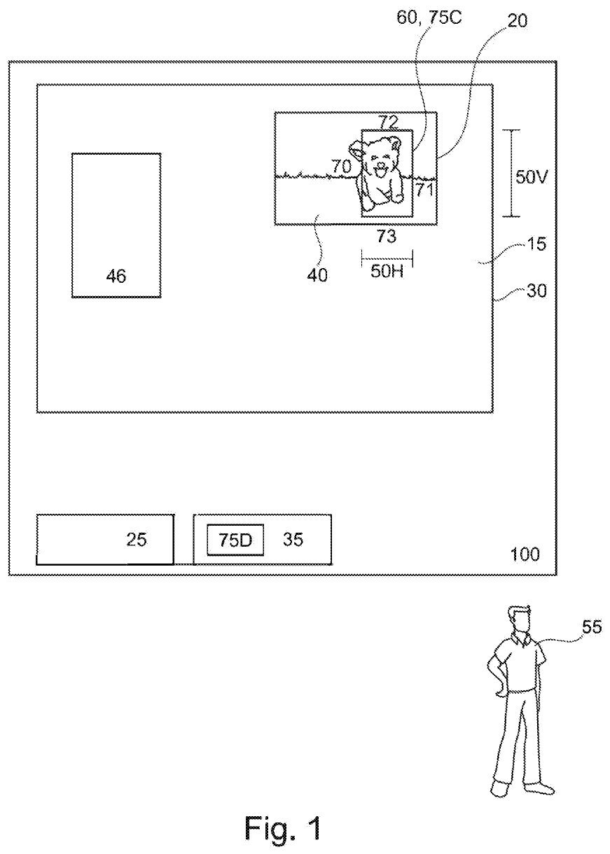

FIG. 1 shows a view of a computer 100 running a computer program for an automatic cropping of a plurality of media elements 20. The computer 100 comprises a graphics processing unit 35, a graphics memory 25, a display unit 30 and is operated by a user 55 to produce or generate a presentation 110 having a canvas 15. The presentation 110 includes one or more presentation objects 46 which can be filled with ones of the plurality of media elements 20. The filling can be carried out by the user 55 using “drag and drop” to move a selected one of the media elements 20 to a selected one of the presentation objects 46. Another method of filling the presentation objects 46 is the use of a file selector dialog to assign one of the media elements 20 to a specific one of the presentation objects 46.

One issue that arises in the filling of the presentation objects 46 with the media elements 20 is the desire to center the media elements 20 within the presentation object 46 and also to crop the size of the media elements 20 to fit the size of the presentation object 46.

The graphics processing unit 35 is used for the task of the centering and the cropping of the media elements 20. The graphics processing unit 35 carries out the centering and the cropping by initially identifying an area of interest 65 within the media elements 20. The area of interest 65 is an area of the media elements 20 that is determined by the graphics processing unit 35 to be of high relevance or importance to the user 55. The graphics processing unit 35 is described as performing perform calculations in the present document, but this is not limiting the invention. The calculations might also be performed by a different processor of the presentation system 10. For example, the identifying of the area of interest 65 and the cropping of the plurality of media elements 20 could also be done by a different processor than the graphics processing unit 35.

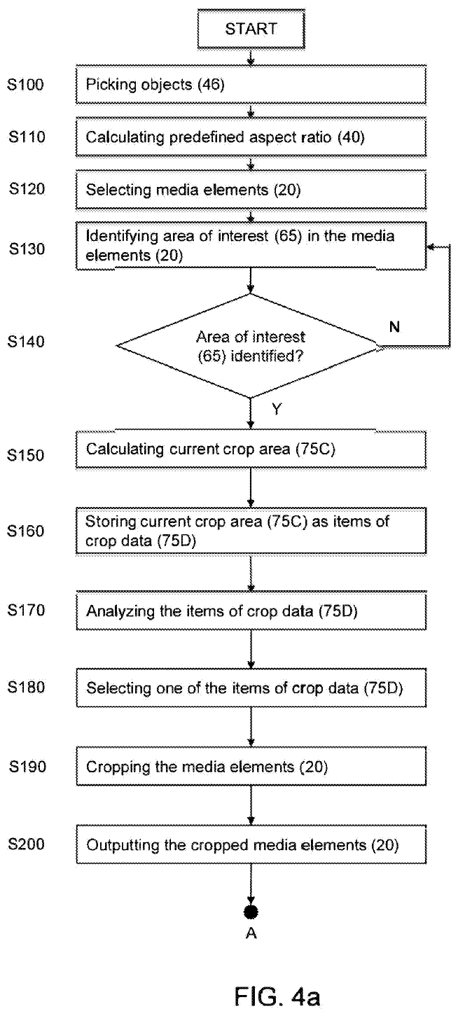

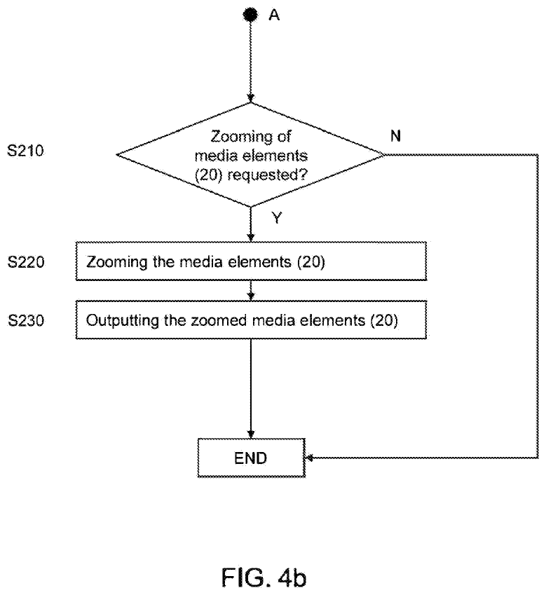

This area of interest 65 could be, for example, the face of a dog running on the grass as depicted in FIG. 1. There could also be other areas of interest 65, as is further elaborated in the description of FIGS. 4a and 4b.

As noted above, the graphics processing unit 35 is able to crop the media elements 20 to fit the presentation objects 46. The graphics processing unit 35 carries out the cropping by establishing a plurality of bounding boxes 60 around the area of interest 65. The area of the media elements 20 enclosed by one of the bounding boxes 60 is termed the current crop area 75c and shows the part of the media element 20 that will be used for the cropping when the media element 20 fills the presentation object 46.

A plurality of current the crop areas 75c is calculated for each of the media elements 20 by the graphics processing unit 35. The plurality of the current crop areas 75c will all 20 have, in one aspect, an identical predefined aspect ratio 40 for each one of the media elements 20. The aspect ratio 40 is the ratio of the horizontal dimension 50h of the current crop area 75c to the vertical dimension 50v of the current crop area 75c. The actual horizontal dimension 50h or the actual vertical dimension 50v might differ in each of the different media elements 20, but the aspect ratio 40 of the current crop area 75c will remain the same.

The graphics processing unit 35 stores the current crop area 75c as one item of crop data 75d in the graphics memory 25. The information stored as items of crop data 75d comprise the current one of the media elements 20, the horizontal dimension 50h and the vertical dimension 50v of the current crop area 75d. The horizontal dimension 50h and the vertical dimension 50v of the current crop area 75d can be expressed as coordinates 85 relative to the corresponding media element 20 which was selected by the user 55. The coordinates 85 can be stored in the graphics memory 25 as absolute values, such as pixels or as a dimension expressed in millimeters in relation to the corresponding media element 20.

The coordinates 85 might also be stored as relative values referring to the size of the respective media element 20, such as a percentage of the horizontal dimension 50h or the vertical dimension 50v of the respective media element 20.

The display unit 30 is used for displaying the canvas 15 of the presentation 110 comprising one or more than one of cropped media elements 20 or uncropped media elements 20 and a plurality of presentation objects 46.

The presentation objects 46 displayed on the canvas 15 can be different types of objects such as placeholder elements, boxes, or other shapes having an internal area for being filled with the media element 20. The presentation objects 46 can, for example, be rectangular shapes, squares, circles, multi-edged shapes, or other types of shapes used for display on the canvas 15. The media elements 20 which are used for filling of the presentation objects 46 have a content 45. The content 45 can, for example, be an image, a text, a graph, or a table. The content 45 of the media elements 20 could also be a video or an image type (such as a .gif-file) showing movement or change over the course of time.

The graphics processing unit 35 analyzes the content 45 of the media element 20 picked by the user 55, for example, when initially drafting the presentation or when placing the media elements 20 on the canvas 15. Analyzing the content 45 comprises detecting the type of content 45 contained in the media element 20 picked by the user 55. The detection of the type of content 45 comprises recognizing different features or patterns within the media elements 20 using the graphics processing unit 20.

In one aspect, this detecting is carried out using a file selector dialog displayed to the user 55. The file selector dialog enables the user 55 to select specific types of the media elements 20 for display in the presentation system 10. The file selector dialog is displayed as a pop-up dialog (also called a “popover” or “media picker popover”) on the display unit 30. The user 55 can also select media elements 20 for replacing those media elements 20 already displayed in the presentation system 10. The presentation system 10 will usually know the type of the media element 20 from the pop-up dialog. In another aspect, the graphics processing unit 35 can detect if the content 45 of the media element 20 is an image, a text, a graph, or a table.

The media elements 20 have a left edge 70, a right edge 71, a top edge 72, and a bottom edge 73 or corresponding coordinates for other shapes (e.g. center and circumference for a circle). The shapes of the media elements 20 can, for example, be rectangular shapes, squares, circles, multi-edged shapes, or other types of shapes used for display on the canvas 15.

The presentation will comprise a number of different presentation objects 46 that the user 55 wants to fill with media elements 20. This can be illustrated by one non-limiting example in which the presentation object 46 is a rectangular shape displayed on the canvas 15. If the user 55 wants to display the media element 20 in the area marked by the presentation object 46, the user 55 can pick or select the presentation object 46 with, for example, a cursor or a pointing device displayed on the display unit 30 of the computer 100. The user 55 then selects the media element 20 for display in the area of the picked/selected presentation object 46, as described above. Upon selecting the media element 20, a computer-implemented method 5 crops the media elements 20 (as will be further elaborated below in the description of FIGS. 4a and 4b). After the cropping, the media element 20 is displayed within the boundaries of the presentation object 46 on the canvas 15.

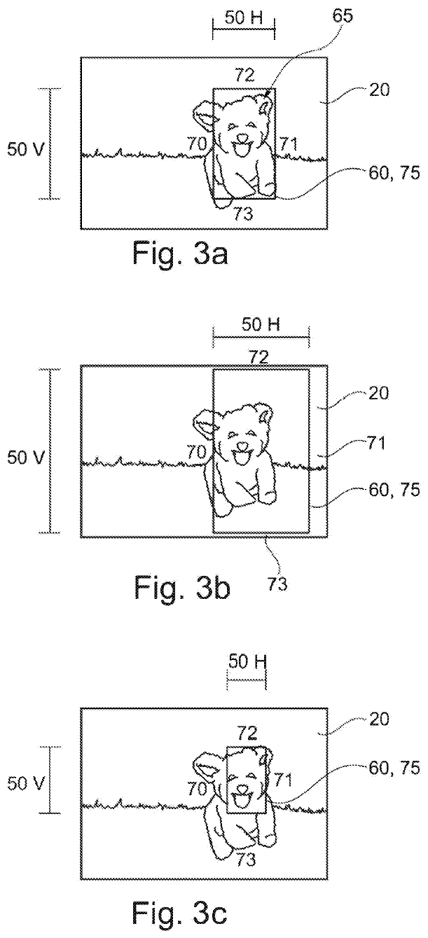

The graphics processing unit 35 determines (see steps S130 to S150 in FIG. 4a) the area of interest 65 and detects a left edge 70, a right edge 71, a top edge 72, and a bottom edge 73 for the area of interest 65 shown in FIGS. 3a to 3c. The bounding box 60 is then calculated (see steps S130 to S150 of FIG. 4a) to include the area of interest 65 having the detected edges 70, 71, 72, 73.

The area of interest 65 is identified by the graphics processing unit 35 using, for example, an identification algorithm, such as smartcrop.js, for analyzing of the media element 20. The analysis of the media element 20 is done using a digital representation of the media element 20, such as a multidimensional tensor. As is known, the multidimensional tensor is an algebraic object that describes relationships between a plurality of objects as a mathematical formula. In this example, the multidimensional tensor is used to derive a saliency map. The deriving of the saliency map is done by the graphics processing unit 35 as will now be explained and the derived saliency map is also represented as a tensor.

The saliency map is calculated by analyzing the pixels of the media element 20 and storing items of data related to the pixels of the media element 20 in the saliency map. The saliency map can be analyzed using standard computing functions such as addition or multiplication. The saliency map has at least one item of data for each pixel in the media element 20.

For example, if the saliency map is a two-dimensional tensor, the items of data identifying the pixels of the media element 20 are stored in the saliency map. If, for example, the media element 20 has the size/shape of 224×128 pixels (width×height), the saliency map identifies each of the pixels in the media element by using a horizontal position and a vertical position of the pixel relative to the media element 20. So, the pixel located at the right edge 71 and the top edge 73 of the media element 20 will be identified by its position, in this case 224 pixels in horizontal direction and 128 pixels in vertical direction.

If, for example, additional items of data should be stored in the saliency map additional dimensions can be added to the tensor and thus to the saliency map. In one example, the media element 20 is stored in a three-dimensional tensor. This third dimension of the tensor enables the graphics processing unit 35 to store items of data relating to each pixel in the tensor representation of the media element 20. Let us take the example in which the media element 20 has the size/shape of 224×128 pixels (width×height). A value representing the colors in the media element 20, for example in an RGB color-scheme, red, green, and blue is stored for every position in the tensor representation of the media element 20. The RGB-color code for the color “black” in the RGB color-scheme is RGB (0,0,0). If the pixel located at the right edge 71 and the top edge 73 of the media element 20 has the color “black”, the tensor representing this pixel of the media element would store the values (0,0,0) in the third dimension of the tensor. The tensor representation of the media element 20 therefore has the shape 224×128×3.

Adding further dimensions to the saliency map, of course, is possible. It would be possible to have both a third dimension and a fourth dimension for the color saturation and the color code. In another example, the fourth dimension might be added for the identification of a batch-size when computing multiple media elements 20 at the same time. The fourth dimension of the saliency map is, for example, a number identifying one of a plurality of media elements 20 stored in a common saliency map. Storing items of data on multiple media elements 20 in one saliency map allows for the parallel calculation of a plurality of media elements 20. The saliency map of the aforementioned example has, if the fourth dimension is added, the shape N×224×128×3, where N indicates the batch-size as an integer.

In the saliency map of the present computer-implemented method 5, the pixels of the media element are assigned a “content score” by the graphics processing unit 35. The assigned content score for the pixels of the media element 20 is based on certain properties of the pixels, such as but not limited to the color of the pixel. For example, the pixel containing a color with high saturation is assigned a higher content score than the pixel containing a color with a lower saturation if saturation is to be a unique property of the pixel in analyzing the media element 20. Therefore, the unique property of the pixels is identified in this dimension and stored in the saliency map. The saliency map of the present computer-implemented method 5 has the shape 224×128×1, because only one dimension is needed to identify the relevancy of a pixel using the content score. Groups or areas with similar content scores for the pixels of the media element 20 can be identified using the saliency map and the graphics processing unit 35. Identifying the areas of similar content is done using a so-called sliding window approach, which will now be explained.

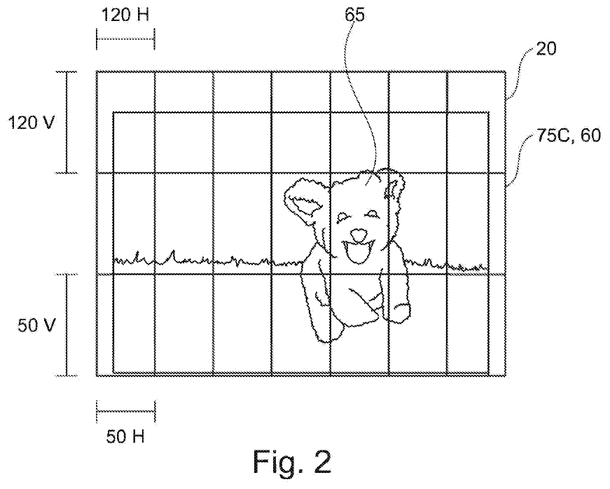

FIG. 2 shows an exemplary view of the sliding window approach. In order to identify the area of interest 65, the graphics processing unit 35 “slides”, or moves horizontally and vertically, the bounding box 60 along the media element 20. In the example depicted in FIG. 2, the bounding box 60 has the horizontal dimension 50h and the vertical dimension 50v. The bounding box 60 is (virtually) moved across the media element 20 by the graphics processing unit 35. The moving of the bounding box 60 is done by changing the horizontal and the vertical coordinates of the bounding box 60 relative to the media element 20 by a horizontal and a vertical increment called step-size or stride 120. In the present example, the horizontal dimension 50h is identical to a horizontal stride 120h. In the present example, the vertical dimension 50v is identical to a vertical stride 120v.

The analysis of the media element 20 is done in multiple steps. In a first step, the bounding box 60 is displayed, for example, at a top left corner of the media element 20. The area marked by the bounding box 60 in this first step is then analyzed by analyzing the digital content of the area within the bounding box 60. An efficient analysis of the media element 20 of the media element 20 is done using, for example, the afore-mentioned saliency map derived from the media element 20. The analyzing is done by, for example, counting the number of pixels within the bounding box 60 having certain saliency values above threshold values indicating colors such as e.g., a skin-like colors in a specific area of the media element 20. Skin-like colors are defined with those having a range of RGB or CMYK values. The graphics processing unit 35 then assigns the area marked by the bounding box 60 a content score indicating the relevancy of the marked area. If, for example, the area marked by the bounding box 60 covers an area with high saliency, the content score of this area will be higher than if the area marked by the bounding box 60 with lower saliency for the pixels in the area. The assigning of the content score by the graphics processing unit 35 can also be referred to as applying/using a selection scheme 80 by the graphics processing unit 35.

In a second step, the bounding box is moved horizontally and/or vertically by the stride 120 to a second position. The area of the saliency map of the media element 20 surrounded by the moved bounding box 60 is then analyzed again in a third step in a manner as already described in the first step. The steps are reiterated until the entire saliency map of the media element 20 has been analyzed by the graphics processing unit 35. The graphics processing unit 35 determines the content score for each of the areas of the areas surrounded by the bounding box 60 as described above. The content scores are stored by the graphics processing unit 35 for later identification of the area of interest 65.

In a further example of the present embodiment, a machine-learning algorithm 95 can be used for identifying the area of interest 65 within the media elements 20 input S250 into the machine-learning algorithm 95 using the saliency map. The machine-learning algorithm 95 comprises a supervised deep learning algorithm, an unsupervised deep learning algorithm, or a reinforcement deep learning algorithm. The machine-learning algorithm 95 comprises proprietary frameworks such as, for example, Tensorflow, Pytorch, or MXNet. Analyzing S260 the media element 20 for identifying of the area of interest 65 using the machine-learning algorithm 95 comprises training the machine-learning algorithm 95 using a training data set containing a plurality of media elements 20. The training data set can be, for example, a plurality of pictures showing people or animals, and which have been classified and form the “ground truth”. The training data set can be proprietary data or also open-source data used for the training of the machine-learning algorithm 95.

The training of the machine-learning algorithm 95 is done using the corresponding derived S270 saliency maps for the sets of classified media elements 20 as the training data. The machine-learning algorithm 95 is taught to output S280 the correct saliency maps, e.g. saliency maps being approximately similar to the ground truth for the media elements 20 in the training data. The training of the machine-learning algorithm 95 therefore comprises comparing S290 the saliency map output by the machine-learning algorithm 95 to the ground truth for the media element 20. If the machine-learning algorithm 95 outputs a saliency map being approximately similar to the ground truth of the media element 20, the machine-learning algorithm 95 is rewarded. If the machine-learning algorithm 95 outputs a saliency map being unsimilar to the ground truth of the media element 20, the machine-learning algorithm 95 is penalized. Rewarding and penalizing the machine-learning algorithm 95 is done for updating S300 of parameters of a model of the machine-learning algorithm 95 using a mathematical function such as a “loss function” as is explained below. The training of the machine-learning algorithm 95 therefore is a problem of mathematical optimization over a set of the parameters of the model where the loss function needs to be minimized.

The loss function is a mathematical function for evaluating a degree of similarity between the saliency map output by the machine-learning algorithm 95 and the ground truth. The loss function returns a numerical value (usually a real number) indicating the degree of similarity. If, for example, there is a high degree of similarity between the ground truth and the output saliency map, the loss function returns a small numerical value. Similar, if, for example, there is a low degree of similarity between the ground truth and the output saliency map, the loss function returns a high numerical value. The loss function therefore indicates how close the saliency map output by the machine-learning algorithm 95 is to the ground truth. The numerical value of the loss function determines how much the machine-learning algorithm 95 should be penalized or rewarded for a current set of model parameters used in the machine-learning algorithm 95 in determining the saliency map.

During the training of the machine-learning algorithm 95, the current set of model parameters of the machine-learning algorithm 95 is updated in such a way that the updated model performs better the next time that the updated model derives the saliency map for a previously evaluated media element 20. It is therefore the goal of the iterations to minimize the numerical value (indicating the degree of similarity) returned by the loss function. Simply put, the model learns from the previous mistakes through comparing the saliency map output by the machine-learning algorithm 95 and the ground truth during the iterations.

In a case where the machine-learning algorithm 95 is a supervised deep learning algorithm, a deep learning training loop for the analyzing of the media element 20 can be applied as follows. Let f be the function of the machine-learning algorithm 95, the media element 20 is analyzed by applying the function f to the media element 20. The multidimensional tensor representing the media element 20 is input (S250) into the function f of the machine-learning algorithm 95. The function f outputs the predicted tensor representing the saliency map of the media element 20. If the media element 20 has, for example, the size of 3×2 pixels (width×height), the output of the function f(img) of the tensor input into the function f could be the following. For sake of brevity, the media element 20 is also referred to as “img” in the following formulae:

f(img)=[[[1.1], [3.1]], [[0.1], [4.0]], [[2.2], [5.1]]]

For example, the training data set for abovementioned media element 20, or “img”, has been classified as ground truth for the media element 20 as the following:

ground_truth(img)=[[[1.5], [3.2]], [[0.4], [5.0]], [[2.1], [5.3]]]

The loss function is input the prediction made by the function f of the machine-learning algorithm 95 and the ground truth from the training data set for the media element 20. The loss returns “0” if the prediction f(img) and the ground_truth(img) are equal. In the present example, the loss function is:

loss(f(img), ground_truth(img)) =3.4

The training algorithm uses the calculated loss function to update the machine-learning algorithm 95. The updated machine learning algorithm 95′, comprising the updated function f′, is again applied to the multidimensional tensor of the medial element 20. The output of the updated function f′ will then be:

f′(img)=[[[1.4], [3.2]], [[0.3], [4.9]], [[2.1], [5.2]]]

Calculating the loss function again returns the following loss value:
loss(f′(img), ground_truth(img))=0.8

As can be seen from the example, the numerical value returned by the loss function has been reduced from 3.4 to 0.8 in the example describing a first step of the iterations. Of course, multiple iterations of the above steps will be conducted to minimize the calculated loss value in the present computer-implemented method 5.

Returning now to the initial example described in FIG. 2, the saliency map of the media element 20 has been analyzed and the content score has been assigned to the areas of interest surrounded by the bounding box 60 in the sliding-window approach. The assigned content scores of the area of interest 65 is compared to a predefined area of interest 65 for the respective media element 20 using the graphics processing unit 35, as will now be shown in the descriptions of FIGS. 3a to 3c.

FIGS. 3a, 3b, and 3c show a detailed view of the media elements 20 with examples of the bounding box 60 as it is calculated by the graphics processing unit 35 using the sliding-window approach described above. In FIGS. 3a to 3c, the sliding window approach is iterated multiple times, now with varying dimensions 50 of the bounding box 60. FIGS. 3a to 3c therefore show the same media element 20 with the bounding box 60 having an identical aspect ratio but different dimensions 50 around the area of interest 65. In FIG. 3a, for example, the graphics processing unit 35 has determined the face of the running dog to be the area of interest 65. Determining the area of interest 65 is done by analyzing the saliency map of the media element 20, as described above. The graphics processing unit 35 assigns the area surrounded by the bounding box 60 the content score. The coordinates 85 of the bounding box 60 are further determined (see steps S130 to S150 of FIG. 4a) by the graphics processing unit 35 to be the current crop area 75c. The current crop area 75c is then stored (in step 160) in the graphics memory 25 as a first item of crop data 75d for later evaluation (see step S170 described in FIG. 4a) by the graphics processor 35 using the selection scheme 80. Storing the first item of crop data 75d also comprises storing the assigned content score.

FIG. 3b shows a second example of the bounding box 60 as it can be calculated by the graphics processing unit 35 (see steps S130 to S150 in FIG. 4a). In this case, the graphics processing unit 35 has determined, using the selection scheme 80, in steps S130 and S140 the area of the dog's face to be the area of interest 65 but has also determined, using the selection scheme 80, that more of the background shown (compared to FIG. 3a) is relevant to the user 55. The bounding box 60 calculated (see steps S130 to S150 of FIG. 4a) for the example shown in FIG. 3b will therefore have a larger horizontal dimension 50h and a larger vertical dimension 50v compared to the bounding box 60 calculated in the example of FIG. 3a. The coordinates 85 of the bounding box 60 calculated for FIG. 3b is then determined, by the graphics processing unit 35, to be the current crop area 75c and stored as second item of crop data 75d.

FIG. 3c shows a third example of the bounding box 60 as it can be calculated by the graphics processing unit 35 (see steps S130 to S150 in FIG. 4a). In this case, the graphics processing unit 35 has determined in step S140 that only the area of the dog's face is the area of interest 65. The bounding box 60 calculated (see steps S130 to S150 of FIG. 4a) for the example shown in FIG. 3c will therefore have a smaller horizontal dimension 50h and a smaller vertical dimension 50v compared to the bounding box 60 calculated for the example of FIG. 3a. The coordinates 85 of the bounding box 60 calculated for FIG. 3c is then determined, by the graphics processing unit 35, to be the current crop area 75c and stored as third item of crop data 75d. The graphics processing unit 35 will select, using the selection scheme 80, one of the items of crop data 75d, as will be elaborated in the description of FIGS. 4a and 4b. The bounding box 60 has the predefined aspect ratio 40 of the presentation object 46 picked by the user 55 for the filling with the media element 20 as calculated in step S110 (shown in FIG. 4a).

FIG. 4a shows a flow chart describing the computer-implemented method 5 for the automatic cropping of the media elements 20 in the presentation system 10. In step S100, the user 55 picks one of the presentation object 46 displayed on the canvas 15 with, for example, a cursor or a pointing device by clicking the one or more presentation objects 46. The user 55 picks the presentation object 46 for the filling with a media element 20. The graphics processing unit 35 calculates, in step S110, the aspect ratio of the picked presentation object 46 and stores the calculated aspect ratio in the graphics memory 25 as a predefined aspect ratio 40. Calculating the predefined aspect ratio 40 is done after the user 55 has picked one of the plurality of presentation objects 46. Calculating the predefined aspect ratio 40 further requires identifying the horizontal dimension 50h of the presentation object 46 and the vertical dimension 50v of the presentation object 46. Identifying the horizontal dimension 50h and the vertical dimension 50v is done by detecting the coordinates 85 of the presentation object 46. The coordinates can, for example, be stored as values of the x-coordinate and the y-coordinate relative to the canvas 15. The predefined aspect ratio 40 is then calculated by dividing, for example, the horizontal dimension 50h by the vertical dimension 50v.

The user 55 selects one of the media elements 20 for the cropping of the media elements 20 to the predefined aspect ratio 40 in step S120. Selecting the media elements 20 can be done, as described above, using functions such as “drag and drop” or a file selector dialog, as described above.

The graphics processing unit 35 identifies in step S130 the area of interest 65 within the media elements 20. Identifying the area of interest 65 within media elements 20 includes detecting one or more of a person, a face, an animal, or a focus point within the media elements. Identifying the area of interest 65 is done using a saliency map as already elaborated above in the description of FIG. 2.

A check is conducted to verify that the graphics processing unit 35 has identified at least one of the area of interest 65 in the picked ones of the media elements 20 in step S140. If the graphics processing unit 35 identifies at least one area of interest 65 in the media elements 20, the current crop area 75c is calculated by the graphics processing unit 35 for the identified areas of interest 65 in step S150. If no area of interest 65 could be identified by the graphics processing unit 35, step S130 is reiterated. In order to determine the current crop area 75c, the graphics processing unit 35 calculates the bounding box 60 around the identified area of interest 65. This is done by identifying the left edge 70, the right edge 71, the top edge 72 and the bottom edge 73 of the area of interest 65. The bounding box 60 is then calculated to surround the area of interest 65 and having the predefined aspect ratio 40 that has been determined in step S110. The graphics processing unit 35 then defines the bounding box 60 to be the current crop area 75c. The graphics processing unit also assigns the current crop area 75c the content score. The coordinates 85 of the current crop area 75c are stored as items of crop data 75d in the graphics memory 25 along with the content score of the current crop area 75c. The coordinates 85 are expressed relative to the respective media element 20 as already described above. Storing the items of crop data 75d is done in step S160.

In step S170, the items of crop data 75d are analyzed by the graphics processing unit 35. The analyzing includes using the selection scheme 80 to identify the item of crop data 75d that includes the area of the media element 20 that is most relevant to the user 55. Using the selection scheme 80, the content score is calculated. The selection scheme 80 is, in some examples, a heuristic function which is a function for ranking alternatives using simple rules. For example, the heuristic function of the selection scheme 80 can be configured to rank those items of crop data 75d higher that show the face of the running dog to be the area of interest 65 (as described in the examples of FIGS. 3a to 3c).

When using a heuristic function, the selection scheme 80 can be configured to select those items of crop data 75d that show (as can be seen in FIG. 3c) only the face of the running dog as the area of interest 65 over those items of crop data 75d that show (as can be seen in FIG. 3b) the face of the running dog and the front of the running dog as the area of interest 65. This selecting of the items of crop data 75d could also be selected by evaluating so-called “zoom-levels” of the items of crop data 75d. The zoom-levels indicate whether the area of interest 65 has been enlarged or not. The selection scheme 80 however, could also use a further trained machine-learning algorithm for the selection of the most relevant item of crop data 75d.

The content score for the current crop area 75c is defined as a number indicating a degree of relevance of the item of crop data 75d. The content score for the item of crop data 75d is, for example, calculated as a weighted sum of the saliency values stored in the saliency map for the pixels in the crop data 75d. One example for the calculation of the content scope uses the following equation:

$${ContentScore}_{CurrentCropArea} = \frac{1}{\begin{matrix}\vert CurrentCropAreaHorizontalDimension * \\ CurrentCropAreaVerticalDimension \vert\end{matrix}} * {\sum }_{( i , j ) CroppedArea} ( [ {λ}_{Skin} * {ContentScore}_{Skin ( i , j )} ] + [ {λ}_{Saturation} * {ContentScore}_{Saturation ( i , j )} ] + [ {λ}_{edge} * {ContentScore}_{Edge ( i , j )} ]$$

This equation defines the content score for the current crop area (ContentScore_{CurrentcropArea}) 75c, which is stored as one item of crop data 75d (see above), as a weighted average of the saliency values (ContentScore) of the items of data stored in the saliency map. The saliency map has, for example, three dimensions containing, in each dimension, items of data for the pixels of the media element 20. As described above, the saliency map identifies each of the pixels in the media element by using a horizontal position of the pixel (i) and a vertical position of the pixel (j) relative to the media element 20. A first dimension of the saliency map is used for a saturation score indicating a saturation of the pixels (ContentScore_{Skin}), a second dimension is used for storing a skin score indicating skin-like colors of the pixels (ContentScore_{Saturation}), and a third dimension is used for storing an edge detection score indicating the presence of an edge or line in the pixels (ContentScore_{Edge}). The content score for each pixel in the current crop area 75c is multiplied by a weighting factor (or weighting coefficient) (λ) indicating a relative weight.

In the above equation, there are three weighting factors used. These three factors are λ_{Saturation} for the weighting of the saturation score, λ_{Skin}, for the weighting of the skin score, and λ_{Edge} for the weighting of the edge detection score. The value of the weighting coefficients (λSaturation, λ_{Skin}, and λ_{Edge}) are chosen depending on the area of the media element 20 to emphasize. For example, if skin-like colors are emphasized, the weighting factor λ_{Skin} will have a higher. The sum of the weighting coefficients is equal one, as is shown in the following equation.

λₛₖᵢₙ+λₛₐₜᵤᵣₐₜᵢₒₙ+λ_{edge}=1

The sum of the weighted content scores for each pixel in the current crop area 75c is calculated and is normalized to compensate different sizes of the current crop area 75c. More specifically, the sum of the weighted content scores of the pixels within the current crop area 75c is multiplied by the reciprocal value of the area of the current crop area 75c, which is the product of the multiplication of the horizontal dimension 50h (CurrentCropAreaHorizontalDimension) and the vertical dimension 50v (CurrentCropAreaVerticalDimension) of the current crop area 75c. The normalizing of the sum of the weighted content scores allows a comparison of the content scores of current crop areas 75c having different horizontal and/or vertical dimensions.

The graphics processing unit 35 selects in step S180 one of the items of the crop data 75d based on the content score for the cropping of the media elements 20. The graphics processing unit 35, applying the selection scheme 80, will pick the current crop data 75c with the highest content score based on the input parameters. For example, the selection scheme 80, if configured to recognize faces, will detect the area of a face within the images of the running dog shown in FIGS. 1 to 3. The item of crop data 75d having the highest content score will then be selected for the following steps.

In step S190 the media elements 20 are cropped using the received predefined aspect ratio 40. The cropped media elements 20 are then output using the graphics processing unit 35 for display on the canvas 15 of the presentation system 10 in step S200.

In one aspect of the method, the steps S130 to S190 are conducted using a tool, for example, smartcrop.js. The steps necessary for the detection of the area of interest 65 and the cropping of the media elements 20 will be similar to the steps described above when using a separate tool.

FIG. 4b shows the further steps of the flow chart describing the computer-implemented method 5 for the automatic cropping of the media elements 20 in the presentation system 10. The graphics processing unit 55, using the computer-implemented method 5, determines in step S210 if the user 55 would like to zoom in on one of the cropped media elements 20. Detecting the user's 55 desire to zoom the media element 20 can be done using, for example, an icon or control menu displayed next the presentation object 46. If the user 55 clicks on the icon or control menu in step S210, the graphics processing unit 35 calculates a zoomed view of the media elements 20 in step S220. In one aspect, the control menu could be as slider displayed next to the presentation object 46. If the user 55 slides the slider, for example, up or down, the zoom level of the media element 20 is increased or decreased accordingly.

Calculating the zoomed view contains enlarging or reducing the size of the media elements 20 using the predefined aspect ratio 40. In one aspect, the area of interest 65 is kept horizontally and vertically centered during the zooming. The zoomed media elements 20 are then outputted to the user 55 in step S230. If, for example, the media element 20 is the picture of the dog (as seen in FIG. 1), the graphics processing unit 35 might determine the area of interest 65 to be the face of the dog (based on the detection mechanisms described above). If the user 55 then wishes to zoom the media element 20, the graphics processing unit 35 zooms the picture focusing on the area of interest 65. This allows to zoom the media element 20 while keeping the area of interest 65 centered within the presentation object 46.

### REFERENCE NUMERALS

5 computer-implemented method
10 presentation system
15 canvas
20 media elements
25 graphics memory
30 display unit
35 graphics processing unit
40 predefined aspect ratio
45 content
50 dimension
50h horizontal dimension
50v vertical dimension
55 user
60 bounding box
65 area of interest
70 left edge
71 right edge
72 top edge
73 bottom edge
75c current crop area
75d crop data
80 selection scheme
85 coordinates
90 position information
95 machine-learning algorithm
100 computer
120 stride
120h horizontal stride
120v vertical stride

1. A computer-implemented method for an automatic cropping of a media elements in a presentation system the computer-implemented method comprising:
identifying an area of interest within the media element, the media element comprising a plurality of pixels;
calculating one or more current crop areas surrounding the area of interest using a graphics processing unit;
storing parameters of the one or more current crop areas as items of crop data in a graphics memory;
selecting one of the items of crop data;
cropping the media elements to the identified area of interest using the selected items of crop data; and
outputting the cropped media elements.

2. The computer-implemented method according to claim 1, wherein:
identifying the area of interest comprises analyzing a digital representation of the media element stored in a multidimensional tensor.

3. The computer-implemented method according to claim 2, wherein:
the digital representation is calculated by analyzing the pixels of the media element using the graphics processing unit.

4. The computer-implemented method according to claim 1 further comprising:
analyzing the pixels of the media element by assigning a content score to a representation of the pixel stored in the multidimensional tensor based on at least one of a color or a saturation of the pixel in the media element.

5. The computer-implemented method according to claim 1, wherein:
calculating the one or more current crop areas comprises setting a bounding box surrounding the identified area of interest, the bounding box having a predefined aspect ratio.

6. The computer-implemented method according to claim 1, further comprising:
receiving a predefined aspect ratio for cropping of the media elements.

7. The computer-implemented method according to claim 5, wherein:
the predefined aspect ratio comprises an information on the ratio of a horizontal dimension to a vertical dimension for cropping of the media elements.

8. The computer-implemented method according to claim 1, further comprising:
analyzing a content of the media element by recognizing different features or patterns within the media elements using the graphics processing unit.

9. The computer-implemented method according to claim 1, wherein:
identifying the area of interest within the media elements comprises detection of at least one of a person, a face, an animal, or a focus point within the media elements

10. The computer-implemented method according to claim 1, wherein:
the identifying the area of interest within the media elements comprises detection of a center of at least one of a text, a graph, or a table.

11. The computer-implemented method (5) according to the above claim 1, wherein:
the identifying the area of interest comprises calculating a plurality of positions of the bounding box relative to the media element, the bounding box having smaller dimensions than the media element.

12. The computer-implemented method according to claim 11, wherein:
the identifying the area of interest further comprises analyzing the pixels of the media element within a calculated position of the bounding box by assigning the content score to the representation of the pixel stored in the multidimensional tensor based on at least one of a color or a saturation of the pixel in the media element.

13. The computer-implemented method according to any of claim 1, wherein:
the identifying the area of interest comprises analyzing the media element using a trained machine-learning algorithm, wherein the machine-learning algorithm is trained using a training data comprising at least one of a classified media element for the training of the machine-learning algorithm.

14. A computer for an automatic cropping of media elements in a presentation system, the computer comprising:
a graphics memory for storing parameters of one or more current crop areas (75c) as the items of crop data;
a graphics processing unit for identifying an area of interest within the media elements, for calculating one or more current crop areas, and for cropping the media elements using the calculated current crop areas; and
a display unit for displaying a canvas comprising one or more than one of the cropped media elements.

15. The computer according to claim 14, further comprising:
the graphics memory for further storing a selection bounding box.

16. A computer-implemented method for training of a machine-learning algorithm for identifying an area of interest in a media element using a saliency map:
inputting the media element for the identifying of the area of interest in the media element by the machine-learning algorithm;
analyzing, by the machine-learning algorithm, the input media element using a graphics processing unit;
deriving, by the graphics processing unit, the saliency map for the analyzed media element (using the machine-learning algorithm;
outputting, by the graphics processing unit, the calculated saliency map;
comparing, by calculating a numerical value for a mathematical loss function, the saliency map of the media element output by the machine-learning algorithm with a predetermined ground truth for the media element; and
updating, using the value calculated for the mathematical loss function, model parameters of the machine-learning algorithm.

17. The computer-implemented method for training of a machine-learning algorithm according to claim 16, wherein:
inputting the media elements comprises using the ground truth including a classified set of training data for training of the machine-learning algorithm.
